(19) United States
(12) Patent Application Publication
(10) Pub. No.: US 2014/0349906 A1
(43) Pub. Date: Nov. 27, 2014

(54) COLOR-PROTECTING WASHING OR CLEANING AGENT

(71) Applicant: Henkel AG & Co. KGaA, Duesseldorf (DE)

(72) Inventors: Birgit Gluesen, Duesseldorf (DE); Mareile Job, Leverkusen (DE); Roland Ettl, Altlussheim (DE); Evgueni Klimov, Ludwigshafen (DE); Christian Schmidt, Ludwigshafen (DE); Markus Brym, Limburgerhof (DE)

(21) Appl. No.: 14/458,363

(22) Filed: Aug. 13, 2014

Related U.S. Application Data
(63) Continuation of application No. PCT/EP2013/052718, filed on Feb. 12, 2013.

(30) Foreign Application Priority Data
Feb. 13, 2012 (EP) 12155186.5

(51) Int. Cl. C11D 17/00; C11D 3/32

(52) U.S. Cl. CPC C11D 17/0034; C11D 3/32
USPC 510/276

(57) ABSTRACT

The color preservation of detergents and cleaners during their use for the washing or cleaning of colored textiles may be improved through the use of fiber-like polyamides in a washing composition. Color transfer inhibition arises through the use of water-insoluble polyamides when these are present in the form of fibers with a small fiber diameter. This invention relates to fibers, compositions and methods relating to inhibition of color transfer in the washing or cleaning of colored textiles.

### FIELD OF THE INVENTION

The present invention generally relates to the use of fibers of water-insoluble polyamides as color-transfer-inhibiting active ingredients during the washing and/or cleaning of textiles, and detergents or cleaners which comprise fibers of this type.

### BACKGROUND OF THE INVENTION

Besides the ingredients that are indispensable for the washing and cleaning process, such as surfactants and builder materials, detergents and cleaners generally comprise further constituents which can be grouped together under the term washing auxiliaries and which comprise such different active ingredient groups as foam regulators, graying inhibitors, bleaches, bleach activators and enzymes. Auxiliaries of this kind also include substances which are intended to prevent colored textile sheet materials bringing about a changed color impression after the washing. This change in color impression of washed, i.e. clean, textiles can be based on the one hand on the fact that dye fractions are removed from the textile by virtue of the washing or cleaning process (“fading”), and on the other hand dyes detached from differently colored textiles can deposit themselves on the textile (“discoloration”). The same applies accordingly for the cleaning of hard surfaces. The discoloration aspect can also play a role in the case of noncolored laundry items if these are washed together with colored laundry items. In order to avoid these undesired secondary effects of removing dirt from textiles by treating with customarily surfactant-containing aqueous systems, detergents, particularly if they are provided as so-called color detergents for washing colored textiles, comprise active ingredients which are intended to prevent the detachment of dyes from the textile or at least avoid the settling of detached dyes present in the wash liquor on textiles. However, many of the customarily used—generally water-soluble—polymers have such a high affinity to dyes that they attract these to an increased extent from the colored fiber, meaning that their use results in color losses. Moreover, some conventional color transfer inhibitors only achieve results with some classes of dye and are unable to prevent the transfer of other classes of dye.

The patent application DE 42 35 798 discloses copolymers of N-vinylpyrrolidone, N-vinylimidazole, N-vinylimidazolium compounds or mixtures thereof, further nitrogen-containing, basic ethylenically unsaturated monomers and optionally other monoethylenically unsaturated monomers and their use for inhibiting dye transfer during the washing process. The patent application DE 196 21 509 describes polymers with an average molar mass above 50 000 g/mol of 5 to 20 mol % of N-vinylimidazole or 4-vinylpyridine N-oxide, 95 to 50 mol % of N-vinylpyrrolidone, N-vinyloxazolidones, methyl-N-vinylimidazole or mixtures thereof and up to 30 mol % of other monoethylenically unsaturated monomers for this purpose. The international patent application WO 03/062362 discloses water-insoluble substrates which carry polyamides as absorber materials for particulate dirt. The international patent application WO 2009/124908 describes the use of particulate water-insoluble polymers, including polyamide, for preventing the transfer of textile dyes from colored textiles to noncolored or differently colored textiles during their combined washing in in particular surfactant-containing aqueous solutions. It is known from the international patent application WO 2009/127587 that porous polyamide particles with a certain particle diameter and a certain particle diameter distribution, certain specific surface area, certain oil absorption capacity and crystallinity avoid the transfer of textile dyes from colored textiles to noncolored or differently colored textiles during their combined washing in in particular surfactant-containing aqueous solutions.

Surprisingly, it has been found that a particularly good color transfer inhibition arises through the use of water-insoluble polyamides when these are present in the form of fibers with a small fiber diameter.

Furthermore, other desirable features and characteristics of the present invention will become apparent from the subsequent detailed description of the invention and the appended claims, taken in conjunction with this background of the invention.

### BRIEF SUMMARY OF THE INVENTION

A detergent, washing additive composition, laundry pretreatment composition or cleaner, comprising a color transfer inhibitor in the form of fibers consisting of water-insoluble polyamide, the average diameter of which is not more than 2 μm, as well as customary ingredients compatible with this constituent.

The use of fibers consisting of water-insoluble polyamide, the average diameter of which is not more than 2 μm, as additives in textile detergent compositions.

The use of fibers consisting of water-insoluble polyamide, the average diameter of which is not more than 2 μm, for avoiding the transfer of textile dyes from colored textiles to uncolored or differently colored textiles during their combined washing in in particular surfactant-containing aqueous solutions, or for avoiding the change in the color impression of textiles during their washing in in particular surfactant-containing aqueous solutions.

A method for washing colored textiles in surfactant-containing aqueous solutions, wherein a surfactant-containing aqueous solution is used which comprises fibers consisting of water-insoluble polyamide, the average diameter of which is not more than 2 μm.

A polyamide fiber of water-insoluble polyamides which have amino groups and optionally carboxyl groups, where, on average, the content of amino groups outweighs the content of carboxyl groups, wherein the average diameter of the polyamide fibers is not more than 2 μm.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The invention provides the use of fibers consisting of water-insoluble polyamide, the average diameter (number average) of which is not more than 2 μm, for avoiding the transfer of textile dyes from colored textiles to noncolored or differently colored textiles during their combined washing in in particular surfactant-containing aqueous solutions.

The invention also relates to the aforementioned polyamide fibers per se insofar as these have basic amino groups and optionally carboxyl groups, where, on average, the content of amino groups outweighs the content of carboxyl groups. Furthermore, the invention relates to sheet materials which comprise these polyamide fibers and in particular consist of these.

In this connection, water-insoluble polyamides are understood as meaning polyamides whose solubility in water is below 3 g/l, preferably below 1 g/l and in particular below 0.1 g/l at 25° C.

The term fiber used here refers to a macroscopically homogeneous and usually flexible body with a high ratio of length to width and a small cross section. Herein, fibers are also understood as meaning filaments and filament-like structures which are characterized by a particularly long length. A general overview of fibers can be found in the ENCYCLOPEDIA OF POLYMER SCIENCE AND ENGINEERING, vol. 6, pp. 647-755 and pp. 802-839, John Wiley and Sons, New York, (1986).

The average diameter (number average) of the polyamide fibers according to the invention or polyamide fibers used according to the invention, which are in particular nanofibers and/or mesofibers, is preferably in the range from 1 nm to 1500 nm, particularly preferably in the range from 10 nm to 1000 nm, in particular in the range from 20 nm to 500 nm and specifically in the range from 50 nm to 250 nm. Nanofibers or mesofibers are understood here as meaning fibers whose diameter is at least not more than 800 nm and generally not more than 500 nm.

The ratio of length to diameter of the polyamide fibers is generally greater than 10, in particular greater than 50 and is generally in the range from 10 to 100 000, preferably in the range from 50 to 50 000 and particularly preferably in the range from 100 to 10 000.

The polyamide fibers can be used in the form of a sheet material. Correspondingly preferred embodiments for the sheet material are a nonwoven or a woven. In this connection, a nonwoven is understood as meaning a sheet material which contains fibers which are arranged, in spatial terms relative to one another, in completely or predominantly random form. By contrast, the fibers in sheet materials which are referred to herein as wovens are arranged completely or predominantly in a regular fashion relative to one another, which is generally brought about by the production method, in particular weaving.

The nonwovens and wovens can comprise one or more groups of polyamide fibers which differ with regard to the dimensions of the fibers, in particular their average diameter, with regard to the polyamides of which the fibers consist, in particular their average molecular weights and also the type and the ratio of the monomers of which they are composed, and/or with regard to the circumstance whether one polyamide or two or more different polyamides are present in the fibers.

Moreover, the nonwovens and wovens can be composed exclusively of the polyamide fibers of the invention or additionally comprise conventional fibers known to the person skilled in the art. It is, for example, possible that they are composed of a mixture of conventional fibers and the polyamide fibers. Additionally, the nonwovens and wovens can comprise further components which are not fibers but which a person skilled in the art would optionally contemplate as a constituent of conventional nonwovens and wovens.

According to a further embodiment, the sheet material consists of a flat support on which the polyamide fibers of the invention are arranged. The support can consist of any material known to the person skilled in the art which can be converted to a flat form. For example, the support may be a woven or nonwoven of conventional type, or a solid surface, such as, for example, a glass plate, or a polymer-containing layer or a polymer-containing film, where polypropylene, polyester, polyamide or cellulose, for example, can be used as polymers. The polyamide fibers can be arranged in any desired manner on the flat support, for example in the form of the above-described nonwovens or wovens. If the sheet material according to the invention comprises a flat support, the weight fraction of the polyamide fibers, based on the total weight of the sheet material, is typically in the range from 1 to 60%, preferably in the range from 3 to 40% and in particular in the range from 5 to 24%.

The polyamide fibers according to the invention or polyamide fibers used according to the invention have a BET surface area in the range from normally 0.01 g/m² to 200 g/m², preferably in the range from 1 to 100 g/m², particularly preferably in the range from 3 to 70 g/m² and in particular in the range from 5 to 50 g/m².

The polyamides from which the polyamide fibers according to the invention or polyamide fibers used according to the invention are formed generally have a number-average molecular weight (Mₙ) in the range from 500 g/mol to 100 000 g/mol, preferably from 500 g/mol to 75 000 g/mol and in particular from 1000 g/mol to 50 000 g/mol. The weight-average molecular weight (M_{w}) is usually in the range from 1000 g/mol to 300 000 g/mol, preferably from 1500 g/mol to 150 000 g/mol and in particular from 2000 g/mol to 100 000 g/mol. The polydispersity index M_{w}/Mₙ characterizing the molecular weight distribution is typically a number in the range from 1 to 10, preferably in the range from 1.5 to 5 and in particular in the range from 2 to 4.

The polyamides forming the polyamide fibers according to the invention or polyamide fibers used according to the invention generally have at least 40 mmol/kg, preferably at least 50 mmol/kg, particularly preferably at least 75 mmol/kg and in particular at least 100 mmol/kg, of basic amino groups. Basic amino groups are understood as meaning those which can be determined by means of titration with aqueous hydrochloric acid solution.

The polyamides forming the polyamide fibers according to the invention or polyamide fibers used according to the invention usually have less than 150, preferably less than 100 mmol/kg, in particular less than 50 mmol/kg and specifically less than 40 mmol/kg, of free carboxyl groups. Accordingly, the polyamides have amino groups and optionally carboxyl groups preferably in a number such that the content of amino groups on average outweighs the content of carboxyl groups. According to a preferred embodiment, the polyamides forming the polyamide fibers have a content of carboxyl groups which is less than 100 meq/kg and is at least 5 meq/kg and in particular at least 10 meq/kg below the content of amino groups, the units of measurement meq/kg and mmol/kg being synonymous with regard to the content of amino groups.

Moreover, according to one embodiment of the invention, the ratio of terminal amino groups to terminal carboxyl groups of the polyamides is generally at least 0.8, preferably at least 1, particularly preferably at least 1.2, in particular at least 1.5 and is typically in the range from 0.8 to 2, preferably in the range from 1.2 to 1.9 and in particular in the range from 1.5 to 1.8.

The polyamides forming the polyamide fibers according to the invention or polyamide fibers used according to the invention consist essentially of aliphatic and optionally cycloaliphatic and/or aromatic structural units, and preferably of aliphatic and optionally cycloaliphatic structural units. The monomer units of which the polyamides are preferably composed therefore essentially comprise either those which are derived from aliphatic or cycloaliphatic diamines and aliphatic or cycloaliphatic dicarboxylic acids or those which are derived from ω-aminocarboxylic acids or lactams thereof. Besides these bifunctional monomer units, ones may also be additionally present which are derived from monomers with further amino groups or carboxyl groups, such as, for example, triamines or diaminocarboxylic acids.

A further parameter suitable for characterizing the polyamides is the molar ratio of amino groups to carboxyl groups, including the derivatized amino groups and carboxyl groups capable of forming the amide, in the totality of the monomers which form the basis of the polyamides. Typically, this molar ratio is in the range from 0.8:1 to 15:1, preferably in the range from 1:1 to 12:1 and in particular in the range from 1.05:1 to 10:1.

According to one embodiment of the invention, the polyamides forming the polyamide fibers comprise at least two different polyamides PA1 and PA2 which differ with regard to the content of amino groups, with regard to the molecular weight Mₙ or with regard to both. For example, a preferred polyamide PA1 has a content of amino groups of at least 45 mmol/kg, in particular at least 55 mmol/kg, or a molecular weight Mₙ in the range from 500 to 25 000 daltons, in particular in the range from 500 to 10 000 daltons, or both. A preferred polyamide PA2, by contrast, has a content of amino groups in the range from 40 to 100 mmol/kg, in particular in the range from 50 to 75 mmol/kg, or a molecular weight Mₙ in the range from 1000 g/mol to 500 000 g/mol, in particular in the range from 1000 g/mol to 50 000 g/mol, or both. In this connection, preferably at least one of the two following conditions is met:

the content of amino groups of the polyamide PA1 is at least 10 mmol/kg, in particular at least 5 mmol/kg greater than that of the polyamide PA2;

the molecular weight Mₙ of the polyamide PA2 is at least 1000 g/mol, in particular at least 500 g/mol higher than the molecular weight Mₙ of the polyamide PA1.

The polyamides forming the polyamide fibers can be present as linear or branched polymers which can optionally be additionally crosslinked. According to a first preferred embodiment, the polyamides are branched. In this connection, the branching points are preferably nitrogen atoms of a tertiary amino group or of a disubstituted amide group. The degree of branching of the polyamides, if they are branched, is typically in the range from 0.05 mol/kg to 15 mol/kg, preferably in the range from 0.1 mol/kg to 7.5 mol/kg and in particular in the range from 0.2 mol/kg to 4 mol/kg. According to a second embodiment, the polyamides are linear. According to a third embodiment, the polyamides are crosslinked.

The polyamides forming the polyamide fibers are preferably produced from monomers which are aliphatic and optionally cycloaliphatic and/or aromatic monomers. This gives rise to the fact that the polyamides consist essentially of aliphatic repeat units and optionally cycloaliphatic and/or aromatic repeat units. This is to be understood as meaning that the molecular moieties of the polyamides which join the functional groups, thus for example amino groups and in particular carboxamide groups, with one another are aliphatic, cycloaliphatic and/or aromatic.

Within the context of this invention, preferred polyamides are essentially composed of repeat units of the formulae Ia and/or Ib; optionally they additionally comprise branching units of the formulae II and/or II′,

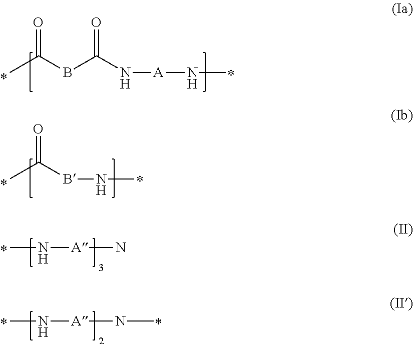

in which
A is selected from alkanediyl radicals having 2 to 20 carbon atoms, in which 1, 2, 3, 4 or 5 nonadjacent CH₂ groups can be replaced by a corresponding number of NH groups, and/or in which two joined together CH₂ groups can be jointly replaced by a C₅-C₇-cycloalkanediyl group, and groups of the formula (A′-O)ₚ-A′, in which A′ is C₂-C₄-alkanediyl, and p is an integer in the range from 1 to 20, where the repeat units A′-O can be identical or different,
A′ is selected from alkanediyl radicals having 2 to 20 carbon atoms, in which 1, 2, 3, 4 or 5 nonadjacent CH₂ groups can be replaced by a corresponding number of NH groups, and/or in which two joined together CH₂ groups can be replaced jointly by a C₅-C₇-cycloalkanediyl group,
B is selected from a covalent bond, alkanediyl radicals having 1 to 20 carbon atoms, in which 2 joined together CH₂ groups can be jointly replaced by a C₅-C₇-cycloalkanediyl group, and
B′ is selected from alkanediyl radicals having 4 to 20 carbon atoms.

The repeat units Ia and Ib generally go back to the polymerization of diamines and dicarboxylic acids or of aminocarboxylic acids or lactams thereof, while the repeat units II and II′, if present, are usually attributed to a polymerization in the presence of amino compounds with one secondary and two primary amino groups or with one tertiary and three primary amino groups.

The term “alkanediyl radical having 2 to 20 carbon atoms”, as used herein, refers to a bivalent group derived from a straight-chain or branched C₂-C₂₀-alkane, such as, for example, methylene, 1,2-ethanediyl, 1,2-propanediyl, 1,3-propanediyl, 1,2-butanediyl, 1,3-butanediyl, 1,4-butanediyl, 2-methyl-1,2-propanediyl, 1,6-hexanediyl, 1,7-heptanediyl, 1,9-nonanediyl, 1,12-dodecanediyl.

The term “C₅-C₇-cycloalkanediyl group”, as used herein, refers to a bivalent group derived from a cycloalkane having 5 to 7 carbon atoms, such as, for example, 1,2-cyclopentanediyl, 1,3-cyclopentanediyl, 1,2-cyclohexanediyl, 1,3-cyclohexanediyl, 1,4-cyclohexanediyl or 1,4-cycloheptanediyl.

In the repeat unit of formula Ia, the radical A is preferably selected from C₂-C₁₀-alkanediyl, C₅-C₂₀-alkanediyl in which 1, 2, 3 or 4 nonadjacent CH₂ groups are in case replaced by NH groups, and groups of the formula (A′-O)ₚ-A′, in which A′ is 1,2-ethanediyl, 1,2-propanediyl, 1,3-propanediyl or 1,4-butanediyl and p is an integer in the range from 1 to 10.

In this connection, the radicals A from the group of the C₂-C₁₀-alkanediyls are preferably selected from C₂-C₈-alkanediyl, specifically from 1,2-ethanediyl, 1,2-propanediyl, 1,3-propanediyl, 1,3-butanediyl, 1,4-butanediyl, 2-methyl-1,2-propanediyl, 1,6-hexanediyl, 1,7-heptanediyl, 1,6-heptanediyl and 1,8-octanediyl, particularly preferably from 1,4-butanediyl, 1,5-heptanyl, 1,6-hexanediyl and 1,7-heptanediyl and in particular the radicals A from the group of the C₂-C₁₀-alkanediyls are 1,6-hexanediyl.

The radicals A from the group of the C₅-C₂₀-alkanediyls, which have in each case NH groups instead of 1, 2, 3 or 4 nonadjacent CH₂ groups, are in particular selected from radicals of the formula [(C₂-C₈)-alkanediyl-NH]ₒ-(C₃-C₈)-alkanediyl where the alkanediyl units are selected independently of one another and o is an integer in the range from 1 to 10 and preferably from 1 to 6. Specifically, such radicals A are selected from radicals of the formula [(C₂-C₆)-alkanediyl-NH]ₒ-(C₃-C₆)-alkanediyl where o is 1, 2 or 3, particularly preferably from (C₂-C₆)-alkanediyl-NH-(C₃-C₆)-alkanediyl, for example 1,6-hexanediyl-NH-1,6-hexanediyl or 1,3-propanediyl-NH-1,3-propanediyl, and [(C₂-C₆)-alkanediyl-NH]₂-(C₃-C₆)-alkanediyl, for example 1,3-propanediyl-NH-1,2-ethanediyl-NH-1,3-propanediyl.

The aforementioned preferred radicals A of the formula (A′-O)ₚ-A′ are in particular selected from (1,2-propanediyl-O)_{q}-1,2-propanediyl, (1,2-ethanediyl-O)_{q}-1,2-ethanediyl, where q is in each case 3, 4, 5, 6, 7 or 8, and (C₂-C₆)-alkanediyl-O-[(C₂-C₆)-alkanediyl-O]ᵣ-(C₂-C₆)-alkanediyl, where r is 1, 2, 3 or 4. Particularly preferably, such radicals A are selected from (1,2-propanediyl-O)_{q}-1,2-propanediyl, where q is 4, 5, 6 or 7, and (C₃-C₅)-alkanediyl-O-[(C₂-C₅)-alkanediyl-O]ᵣ-(C₃-C₅)-alkanediyl, where r is 1, 2 or 3, specifically from (1,2-propanediyl-O)_{q}-1,2-propanediyl where q=5 or 6, 4,9-dioxadodecane-1,12-diyl and 4,7,10-trioxatridecane-1,13-diyl.

In the repeat units of the formulae II and II′ the radicals A″, independently of one another, are preferably selected from the radicals specified as being preferred for the radical A.

In addition to the aforementioned repeat units, the polyamides can also comprise repeat units which differ from those of the formula Ia in that the unit-NH-A-NH- is replaced by a bivalent heterocyclyl radical having at least 2 nitrogen atoms in the ring and an optional (C₁-C₁₀)-aminoalkyl substituent. The term “heterocyclyl” refers here to a 5- or 6-membered monocyclic or an 8- to 10-membered bicyclic heterocyclic radical which comprises 2 nitrogen atoms and optionally 1 or 2 further heteroatoms selected from N, O and S as ring atoms, where the heterocyclic radical can be saturated, partially saturated or aromatic. Within the polyamide, the heterocyclic radical is bonded either via two ring nitrogen atoms or via one ring nitrogen atom and the nitrogen atom of the optional aminoalkyl group. The heterocyclic radical is therefore preferably derived from heterocycles which comprise either two secondary amino groups or, if it is substituted with an aminoalkyl group, one secondary amino group. Examples of such heterocycles are imidazole, pyrazole, triazole, tetrazole, benzimidazole, purine and piperazine.

The specified repeat units comprising one bivalent heterocyclyl are preferably selected from monocyclic saturated and partially saturated 5- or 6-membered monocyclic heterocycles having 2 nitrogens, such as piperazine, and monocyclic partially saturated and aromatic 5- or 6-membered monocyclic heterocycles having 2 nitrogen atoms which are N-substituted with a (C₁-C₁₀)-aminoalkyl group, such as N-(3-aminopropyl)imidazole.

In the repeat unit of the formula Ia, the radical B is preferably selected from a covalent bond and C₁-C₁₀-alkanediyl. In particular, B is selected from C₁-C₇-alkanediyl, specifically from methylene, 1,2-ethanediyl, 1,2-propanediyl, 1,3-propanediyl, 1,3-butanediyl, 1,4-butanediyl, 2-methyl-1,2-propanediyl, 1,5-pentanediyl, 1,6-hexanediyl and 1,7-heptanediyl, particularly preferably from 1,3-propanediyl, 1,4-butanediyl, 1,5-heptanyl and 1,6-hexanediyl. B is particularly preferably 1,4-butanediyl.

In the repeat unit of the formula Ib, the radical B′ is preferably selected from C₄-C₁₀-alkanediyl. In particular, B′ is selected from C₄-C₆-alkanediyl, specifically from 1,4-butanediyl, 1,5-pentanediyl and 1,6-hexanediyl, and B′ is particularly preferably 1,5-pentanediyl.

In addition to the meanings specified above for the radical B, B can also be selected from the group of the bivalent C₆-C14-arylene radicals, i.e. the group of C₆-C₁₄-arylenediyls, which are bivalent mono- or polycyclic aromatic hydrocarbons. The C₆-C₁₄-arylenediyls can be unsubstituted or have 1 or 2 substituents which are selected from C₁-C₄-alkyl, C₁-C₄-alkoxy and SO₃H, in particular from C₁-C₂-alkyl, C₁-C₂-alkoxy and SO₃H. Radicals B from the group of the C₆-C₁₄-arylenediyls are preferably selected from C₆-C₁₀-arylenediyl, specifically from 1,3-phenylene, 1,4-phenylene, 1,4-naphthylene, 1,3-naphthylene, 1,5-naphthylene, 2,6-naphthylene, 2,7-naphthylene and 1,6-naphthylene, which are unsubstituted or have 1 or 2 substituents selected from methyl, ethyl, methoxy and SO₃H.

According to preferred embodiments of the invention, the polyamide fibers according to the invention comprise at least one polyamide which is essentially composed of repeat units of the formula Ia, where the radicals A are preferably C₄-C₇-alkanediyl, specifically 1,6-hexanediyl, and the radicals B are preferably C₂-C₅-alkanediyl, specifically 1,4-butanediyl. Particular preference is given to polyamide fibers which comprise PA 6.6, i.e. a polyamide consisting of repeat units Ia where A=1,6-hexanediyl and B=1,4-butanediyl.

According to further preferred embodiments of the invention, the polyamide fibers according to the invention comprise at least one polyamide which is composed essentially of repeat units of the formula Ib, where the radicals B′ are preferably C₄-C₆-alkanediyl, specifically 1,5-pentanediyl. Particular preference is given to polyamide fibers which comprise PA 6, i.e. a polyamide consisting of repeat units Ib where B′=1,5-pentanediyl.

According to particularly preferred embodiments of the invention, the polyamide fibers according to the invention comprise at least both a polyamide which is essentially composed of repeat units Ia and also a polyamide which is essentially composed of repeat units Ib, where the radicals A, B and B′ preferably have the meanings given in the preferred embodiments above. The polyamide fibers preferably comprise both PA 6.6 and also PA 6, or consist, according to a particularly preferred embodiment, of PA 6.6 and PA 6.

The polyamides forming the polyamide fibers can be prepared by the processes known from the prior art for the preparation of poly- and oligoamides. Of suitability for this purpose are in particular polycondensation reactions of monomers which comprise primary or secondary amino groups or isocyanate groups and/or carboxyl groups or amide-forming groups derived therefrom. Preference is given to monomers M1 with two or more, in particular two or three, primary amino groups or isocyanate groups, monomers M2 with two or three, in particular two, carboxyl groups or amide-forming groups derived therefrom, and monomers M3, which are either compounds with one or two, in particular with one, primary amino group or isocyanate group and with one or two, in particular one, carboxyl group or a corresponding amide-forming group, or lactams derived from these compounds. Hereinbelow, the monomers M2 and M3 are collectively referred to as amide-forming compounds.

The monomers M1 used are in particular aliphatic and optionally cycloaliphatic and/or aromatic di- and triamines with two or three, in particular two, primary amino groups. Preference is given to monomers M1 selected from diamines of the formula V1,

H₂N-A-NH₂ (V1)

in which the bivalent radical A has the meanings described herein, in particular the meanings specified herein as being preferred. Particularly preferred monomers M1 are diamines V1 in which A is 1,4-butanediyl, 1,5-pentanyl, 1,6-hexanediyl or 1,7-heptanediyl and specifically 1,6-hexanediyl. These preferred monomers M1 are accordingly 1,4-diaminobutane, 1,5-diaminopentane, 1,6-diaminohexane or 1,7-diaminoheptane and specifically 1,6-diaminohexane.

Suitable further monomers having at least two amino groups for the preparation of the polyamides are also the above-described heterocycles, which either comprise two secondary amine groups or, if they are substituted with a (C₁-C₁₀)-aminoalkyl group, a secondary amino group. In the text below, such heterocycles are referred to as monomers M1′. Preferred monomers M1′ are saturated and partially saturated 6-membered rings which comprise two secondary amine groups as ring members, in particular piperazine, and aromatic 5- or 6-membered rings with one secondary and one tertiary amine group, and also an N-linked (C₁-C₆)-aminoalkyl group, in particular the N-(C₁-C₆)-aminoalkyl-substituted derivatives of imidazole, pyrazole, triazole, tetrazole, benzimidazole, purine and piperazine, specifically N-(3-aminopropyl)imidazole.

Monomers M2 used are in particular aliphatic and optionally cycloaliphatic and/or aromatic dicarboxylic acids and amide-forming derivatives thereof. The amide-forming derivatives are in particular the aforementioned dicarboxylic acids in which one or both carboxyl groups are replaced by ester groups, nitrile groups, carboxylic anhydride groups and carboxylic acid halide groups, preferably carbonoyl chloride groups. Preference is given to monomers M2 selected from dicarboxylic acids of the formula V2,

HOOC-B-COOH (V2)

and amide-forming derivatives thereof, in which B is selected from a covalent bond, alkanediyl radicals having 1 to 20 carbon atoms, in which two joined together CH₂ groups can be jointly replaced by a C₅-C₇-cycloalkanediyl group, and arylene, which is unsubstituted or has 1, 2 or 3 substituents which are selected from C₁-C₄-alkyl, C₁-C₄-alkoxy and SO₃H.

Particularly preferred monomers M2 are dicarboxylic acids V2 and amide-forming derivatives thereof in which B is selected from a covalent bond and C₁-C₁₀-alkanediyl, in particular from C₁-C₇-alkanediyl, specifically from methylene, 1,2-ethanediyl, 1,2-propanediyl, 1,3-propanediyl, 1,3-butanediyl, 1,4-butanediyl, 2-methyl-1,2-propanediyl, 1,5-pentanediyl, 1,6-hexanediyl and 1,7-heptanediyl, particularly preferably from 1,3-propanediyl, 1,4-butanediyl, 1,5-heptanyl and 1,6-hexanediyl. Particularly preferred monomers are dicarboxylic acids V2 and amide-forming derivatives thereof in which B is 1,4-butanediyl. These particularly preferred monomers M2 are accordingly adipic acid and amide-forming derivatives thereof.

The monomers M3 used are in particular aliphatic ω-aminocarboxylic acids with 4, 5 or 6 carbon atoms and lactams thereof. Preferred monomers M3 are 4-aminobutanoic acid, 5-aminopentanoic acid and 6-aminohexanoic acid, and lactams thereof pyrrolidin-2-one, piperidin-2-one and ε-caprolactam. Particularly preferred monomers M3 are 6-aminohexanoic acid, pyrrolidin-2-one, piperidin-2-one and ε-caprolactam, and specifically ε-caprolactam.

The polyamides forming the polyamide fibers according to the invention or polyamide fibers to be used according to the invention are preferably obtainable by reacting at least one monomer M3, or alternatively by reacting monomers comprising at least one amino compound which has two primary amino groups, and at least one amide-forming compound which is selected from dicarboxylic acids, amide-fowling derivatives thereof and lactams.

Preferably, the at least one monomer M3, further preferably one or two monomers M3 and in particular one monomer M3 selected from aliphatic ω-aminocarboxylic acids having 4, 5 or 6 carbon atoms and lactams thereof, is reacted.

The at least one amino compound with 2 primary amino groups, preferably selected from monomers M1 and particularly preferably from diamines of the formula V1, is preferably reacted with at least one dicarboxylic acid, in particular selected from dicarboxylic acids of the formula V2 or an amide-forming derivative thereof. In this connection, the at least one amino compound is used, based on 1 mol of the at least one dicarboxylic acid, usually in an amount of at least 1 mol, preferably of at least 1.05 mol, in particular of more than 1.1 mol and particularly preferably of more than 1.25 mol.

The reactions according to the above preferred embodiment are preferably carried out with one or two different and particularly preferably with one dicarboxylic acid or an amide-forming derivative thereof. If the reactions are carried out with two different dicarboxylic acids or amide-forming derivatives thereof, their molar ratio is generally in the range from 20:1 to 1:1, preferably in the range from 15:1 to 1:1 and in particular in the range from 10:1 to 1:1.

In the reactions according to the above preferred embodiment, the dicarboxylic acids are preferably selected from adipic acid or an amide-forming adipic acid derivative and mixtures thereof with a further different dicarboxylic acid V2 or amide-forming derivative thereof.

According to a further preferred embodiment, the at least one amino compound with 2 primary amino groups, preferably selected from monomers M1 and particularly preferably from diamines of the formula V1, is reacted with at least one amide-forming compound selected from monomers M3, in particular from lactams of aliphatic ω-aminocarboxylic acids having 4, 5 or 6 carbon atoms, and mixtures thereof with monomers M2. In this embodiment, the at least one monomer M3 is used, based on 1 mol of the at least one amino compound, preferably in an amount of more than 3 mol, in particular of more than 6 mol and particularly preferably of more than 12 mol.

The monomers M3 are preferably selected from the lactams of aliphatic ω-(C₄-C₆-aminocarboxylic acids and mixtures thereof with one or more dicarboxylic acids or amide-forming derivatives thereof. In particular, the at least one monomer M3 is caprolactam. If the reactions according to the above preferred embodiment are carried out with a lactam and one or more dicarboxylic acids or amide-forming derivatives thereof, the molar ratio of lactam to dicarboxylic acids or dicarboxylic acid derivatives is generally in the range from 20:1 to 1:10, preferably in the range from 15:1 to 1:5 and in particular in the range from 10:1 to 1:2.

In the three embodiments described above, the terms monomer M1, diamine of the formula V1, amide-forming derivative of a dicarboxylic acid, monomer M2, monomer M3 and lactam have the meanings defined above and in particular the meanings specified as being preferred.

The reactions according to the two last-mentioned preferred embodiments are preferably carried out with an amino compound which has 2 primary amino groups, or with two or more different, in particular two different, amino compounds having 2 primary amino groups. In the case of two or more amino compounds having 2 primary amino groups, the second and all further amino compounds are preferably selected from monomers M1. In this connection, preference is given in particular to those monomers M1 which correspond to the diamines of the formula V1 where the radical A is preferably selected from C₂-C₈-alkanediyl, such as 1,4-butanediyl, 1,5-heptanyl, 1,6-hexanediyl or 1,7-heptanediyl, [(C₂-C₆)-alkanediyl-NH]ₒ-(C₃-C₆)-alkanediyl with alkanediyl units selected independently of one another and o=1, 2 or 3, such as N,N′-bis(3-aminopropyl)ethylenediamine, and (C₂-C₆)-alkanediyl-O-[(C₂-C₆)-alkanediyl-O]ᵣ-(C₂-C₆)-alkanediyl where r=1, 2, 3 or 4, such as 4,9-dioxadodecane-1,12-diamine or 4,7,10-trioxatridecane-1,13-diamine. If the reactions are carried out with two different amino compounds having 2 primary amino groups, the molar ratio of the two amino compounds is generally in the range from 20:1 to 1:1, preferably in the range from 15:1 to 1:1 and in particular in the range from 10:1 to 1:1. If the reactions are carried out with more than two different amino groups having 2 primary amino groups, the molar ratio of one amino compound relative to the sum of all of the other amino compounds is generally in the range from 1:30 to 1:1, preferably in the range from 1:20 to 1:1 and in particular in the range from 1:15 to 1:2.

In the reactions according to the two last-mentioned preferred embodiments, the amino compounds with 2 primary amino groups are preferably selected from 1,6-diaminohexane and mixtures thereof with at least one further diamine V1 different therefrom. The amino compounds with 2 primary amino groups are particularly preferably selected from 1,6-diaminohexane and mixtures thereof with a further diamine V1 different therefrom. Moreover, these reactions can be carried out in the presence of at least one triamine with three primary amino groups. Preferred triamines are selected from compounds of the formulae V3 and V4,

N-(V-NH₂)₃ (V3),

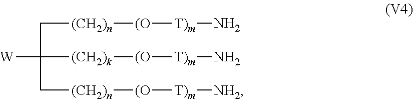

in which V is a bivalent aliphatic radical and is in particular C₂-C₁₀-alkanediyl, W is hydrogen or an aliphatic radical and is in particular hydrogen or C₁-C₆-alkyl, T is C₂-C₄-alkanediyl, in particular 1,2-ethanediyl, 1,2-propanediyl, 1,3-propanediyl, 1,2-butanediyl, 1,3-butanediyl, 1,4-butanediyl or 2-methyl-1,2-propanediyl and is specifically 1,2-ethanediyl or 1,2-propanediyl, n and k, independently of one another, are 0, 1, 2, 3 or 4 and are in particular 0 or 1, and m is an integer in the range from 1 to 20 and in particular from 3 to 8.

If the reactions are carried out in the presence of at least one triamine with three primary amino groups, the molar ratio of the at least one triamine to the at least one amino compound having two primary amino groups is generally in the range from 1:1 to 1:50, preferably in the range from 1:3 to 1:30 and in particular in the range from 1:10 to 1:25.

If at least one triamine having three primary amino groups is used in the reactions, preferably only one such triamine is used in combination with one or two, in particular one, amino compound having 2 primary amino groups.

The reactions to give the polyamides forming the polyamide fibers according to the invention or polyamide fibers used according to the invention can take place analogously to known prior art processes by polycondensation of the bivalent monomers, as described, for example, in “Technische Polymere [Technical polymers], chapter 4: Polyamide [Polyamides]”, ed. L. Bottenbruch and R. Binsack, 1998, Hanser (Munich, Vienna). The reaction conditions naturally depend on the type and functionality of the monomers used.

A suitable process for the preparation of the polyamides is thermal polycondensation. In this process, a monomer mixture, which preferably comprises dicarboxylic acids and diamines, is reacted at comparatively high temperatures, for example in the range from 180 to 350° C., in particular from 220° C. to 300° C. and as a rule increased pressures of from 0.8 to 30 bar, in particular 5 to 20 bar. The reaction can take place without a diluent, in solution or in suspension. Preferably, the reaction is carried out in a solvent suitable for the reaction. In the case of the dicarboxylic acids and diamines, water in particular is suitable as solvent. Here, the water fraction in the reaction mixture is usually 20 to 80, in particular 30 to 60, mass percent with regard to the initial weight of monomer. If a high water fraction is used for the reaction, which can optionally also be above the aforementioned upper range limits, the polyamides can be obtained present in aqueous dispersion. Such a primary dispersion can be passed directly to one of the spinning processes described below for producing the polyamide fibers according to the invention. If the monomer mixture comprises lactams and diamines, the polyamides are preferably produced by means of hydrolytic polycondensation, which is likewise preferably carried out in a temperature range from 180 to 350° C., in particular from 220 to 300° C. and at pressures of 0.8 to 30, in particular 5 to 20 bar. In this connection, a comparatively small water fraction of 1 to 30, in particular 3 to 12, mass percent with regard to the initial weight of the monomer is used, in which the lactam is generally present in dispersed form. Alternatively, monomer mixtures which comprise lactams can be converted to the polyamides by alkaline polymerization with the exclusion of water at generally somewhat lower temperatures. If monomer combinations are used which comprise amide-forming derivatives of diamines or dicarboxylic acids, such as, for example, diisocyanates and dicarboxylic acids, diamines and dicarbonyl dichlorides or diamines and dinitriles, the polycondensation reaction is preferably carried out in solution and optionally in the presence of a catalyst.

The work-up of the crude products obtained in the aforementioned processes takes place usually by drying and subsequent grinding to give a powder or by dissolving, for example in a moderately polar organic solvent, such as, for example, phenols, cresols and benzyl alcohol, the solvent being selected in some circumstances already with regard to its suitability for the fiber spinning process which is to be used subsequently. If an aqueous dispersion of the polyamides is to be used for the spinning process, the aforementioned solutions can be further processed in organic solvents by means of precipitation with very polar solvents, such as methanol, water or acetone, and subsequent dispersion in water. A solution of the polyamides in an organic solvent, such as for example formic acid, to be used for the spinning process can also be prepared starting from the aforementioned dried and ground crude product or from the aforementioned precipitation product. The polyamides obtained in this way in the form of a solution in an organic solvent or an aqueous dispersion can be used directly in fiber spinning processes. The weight-average particular diameter of the polyamides present in aqueous dispersion can be determined by means of methods known from the prior art, such as, for example, sieve analysis or light scattering, and is typically in the range from 1 nm to 50 μm, preferably in the range from 10 nm to 25 μm and in particular in the range from 20 nm to 10 μm.

To produce nanofibers and mesofibers, a large number of methods are known to the person skilled in the art, with the greatest importance currently being attributed to the electrostatic spinning method (“electrospinning”). In this method, which is described for example by D. H. Reneker, H. D. Chun in Nanotechn. 7 (1996), page 216 f., a polymer melt or a polymer solution at an edge serving as electrode is exposed to a high electrical field. This can be achieved, for example, by extruding the polymer melt or polymer solution in an electrical field under slight pressure through a cannula joined to one pole of a voltage source. The electrostatic charging of the polymer melt or polymer solution produced thereby results in a material flow directed toward the counterelectrode, which solidifies on the way to the counterelectrode. Depending on the electrode geometries, this method produces sheet materials such as nonwovens or assemblies of ordered fibers. A detailed description of the electrospinning method can also be found in A. Greiner and J. Wendorff, Angew. Chemie Int. Ed., 2007, 119, 5770-5805. This publication moreover describes the properties of the fibers produced by this method and their possible applications.

A further suitable method for producing sheet materials which are composed of fibers is the rotor spinning or centrifuge spinning method. In this method, the starting material is introduced in the form of a solution or finely divided dispersion into a field with gravitational forces. For this purpose, the fluidized fiber raw material is placed in a container and the container is set to rotate, during which the fiber raw material is discharged from the container in the form of fibers by centripetal or centrifugal forces. The fibers can then be transported away by gas flow and combined to give sheet materials.

The preparation of the polyamide fibers according to the invention or polyamide fibers used according to the invention and of the sheet materials according to the invention or sheet materials used according to the invention and comprising such fibers can take place by any method known to the person skilled in the art. Of suitability for this are in particular the aforementioned electrospinning and rotor spinning methods.

The electrospinning method has proven to be particularly suitable, with which the polyamide fibers of the invention can generally be obtained directly in the form of sheet materials according to the invention or sheet materials used according to the invention. For this, the polymer threads formed during the electrospinning method are laid on one of the aforementioned flat supports or on a conveyor belt, for example on a polypropylene substrate, whereupon, as a result of the polymer threads blending and mingling with one another, a sheet material is formed. In this connection, it is for example possible to carry out the electrospinning method such that at least two spinning jets are arranged at an angle relative to one another and the polymer threads exiting the spinning jets blend and mingle together before meeting on the conveyor belt.

Preference is given to methods which permit the electrostatic spinning of essentially water-insoluble polyamides in the form of solutions in organic solvents or in the form of aqueous dispersions. As regards the electrostatic spinning of aqueous colloidal polymer dispersions, the international patent applications WO 2006/089522 and WO 2009/074630 disclose suitable methods. Organic solvents which can be used for producing polyamide solutions for use in electrospinning methods are preferably polar to very polar organic solvents, in particular formic acid and acetic acid, specifically formic acid.

The polyamide fibers according to the invention or polyamide fibers used according to the invention and also the sheet materials according to the invention or sheet materials used according to the invention are particularly preferably produced by means of electrospinning methods which correspond to one of the two following variants.

Variant 1: the formulation in the form of a solution, a colloidal dispersion or a melt of a polyamide or polyamide mixture is introduced into an electrical field with a strength of in general between 0.01 and 10 kV/cm, preferably between 1 and 6 kV/cm and in particular between 2 and 4 kV/cm by squeezing it out of one or more cannulae under slight pressure. As soon as the electrical forces exceed the surface tension of the drops at the cannula tip(s), mass transfer takes place in the form of a jet onto the opposite electrode. Any solvent present evaporates in the interelectrode space and the solid material in the formulation is then present in the form of fibers on the counterelectrode. Spinning can take place in both vertical directions (upwardly and downwardly) and in the horizontal direction.

Variant 2: this variant is carried out with equipment which comprises a cylinder or a drum, such as, for example, the “nanospider” system from Elmarco (Czech Republic). The formulation, in the form of a solution, a dispersion or a melt of a polyamide or polyamide mixture, is located either in a container in which a metal drum rotates permanently, or is metered onto the drum by means of a separate device. The drum can be smooth, structured or equipped with metal wires. The drum surface is always covered at least partly with some of the formulation. The electric field between the drum and the counterelectrode, which is generally located above the drum, causes the formulation located on the drum to initially form liquid jets which then, on their way to the counterelectrode, solidify to give polyamide fibers as a result of evaporation of the solvent and/or cooling of the melt. The desired sheet material comprising polyamide fibers is formed on a flat support (e.g. polypropylene, polyester or cellulose), which is located between the two electrodes and/or runs between the two electrodes. The electric field generally has the strength given in variant 1. The electric field here particularly preferably likewise has a strength of about 2 kV/cm to 4 kV/cm. Spinning can take place in both vertical directions (upwardly and downwardly) and in the horizontal direction.

In an optional subsequent process step, the fiber sheet materials obtained by the methods of variants 1 and 2 can be treated at temperatures above the melting temperature or glass transition temperature in order to bond the fibers at the intersections. If a formulation is used in the form of a dispersion, by means of the aforementioned optional process step, the strings of polyamide particles or of short polyamide fibers possibly formed initially during the electrospinning from the jets can, moreover, be joined to give polyamide fibers according to the invention.

In the course of a manual or machine washing or cleaning process, the polyamide fibers can be added separately to the washing solution, for example as a constituent of a washing additive. They are preferably brought into contact with the textile as a constituent of a pretreatment composition in a step which precedes the actual washing process, or are furthermore preferably introduced into the washing or cleaning solution as a constituent of a detergent or cleaner.

The invention provides the use of fibers consisting of water-insoluble polyamide, the average diameter of which is not more than 2 μm, as additives in textile detergent compositions. In this connection, the polyamide and the fibers consisting thereof have the aforementioned properties, in particular the properties specified as being preferred or particularly preferred. The use of such polyamide fibers in a laundry pretreatment step is also possible, in which case the polyamide-containing pretreatment composition is then preferably not washed out, but remains on the textile planning to be washed and passes together with this into the wash liquor.

The invention therefore further provides a color-protecting detergent, washing additive composition, laundry pretreatment composition or cleaner, comprising a color transfer inhibitor in the form of above-described fibers consisting of water-insoluble polyamide, the average diameter of which is not more than 2 μm, as well as customary ingredients compatible with this constituent.

A composition according to the invention comprises preferably 0.05% by weight to 20% by weight, in particular 0.1% by weight to 5% by weight, of the polyamide fibers. Incorporation into the respective formulation takes place in a manner known per se, it being possible to use the polyamide fibers in the form of the unbonded fibers or in the form of the sheet materials according to the invention. The unbonded fibers generally remain in the wash liquor and are separated from the textiles to be washed by discharging them with the wash liquor.

The polyamide fibers make a contribution to both aspects of color constancy discussed at the start, i.e. they reduce both discoloration and fading, although the effect of preventing staining, in particular during the washing of white textiles, is most pronounced. The invention therefore further provides the use of fibers consisting of water-insoluble polyamide, the average diameter of which is not more than 2 μm, for avoiding the change in the color impression of textiles during their washing in in particular surfactant-containing aqueous solutions. Change in the color impression is in no way to be understood as meaning the difference between soiled textile and clean textile, but the color difference between clean textile before and after the washing process.

The invention further provides a method for washing colored textiles in surfactant-containing aqueous solutions, which comprises using a surfactant-containing aqueous solution which comprises the above-described fibers consisting of water-insoluble polyamide, the average diameter of which is not more than 2 μm. In such a method, it is possible to also wash white or noncolored textiles together with the colored textile without the white or uncolored textile becoming stained. The concentration of the polyamide fibers in the surfactant-containing aqueous solution here is preferably 0.025 g/l to 5 g/l, in particular 0.2 g/1 to 2.5 g/l.

Besides the specified color-transfer-inhibiting active ingredient, a composition according to the invention can if desired also additionally comprise a known color transfer inhibitor, preferably in amounts of from 0.01% by weight to 5% by weight, in particular 0.1% by weight to 1% by weight, which, in a preferred embodiment of the invention, is a polymer of vinylpyrrolidone, vinylimidazole, vinylpyridine N-oxide or a copolymer of these. It is possible to use either polyvinylpyrrolidones with molecular weights of from 15 000 to 50 000 or polyvinylpyrrolidones with molecular weights above 1 000 000, in particular from 1 500 000 to 4 000 000, N-vinylimidazole/N-vinylpyrrolidone copolymers, polyvinyloxazolidones, polyamine N-oxide polymers, polyvinyl alcohols and copolymers based on acrylamidoalkenylsulfonic acids. However, it is also possible to use enzymatic systems comprising a peroxidase and hydrogen peroxide or a substance which produces hydrogen peroxide in water. The addition of a mediator compound for the peroxidase, for example an acetosyringone, a phenol derivative or a phenothiazine or phenoxazine, is preferred in this case, where also additionally aforementioned conventional polymeric color transfer inhibitor active ingredients can be used. Polyvinylpyrrolidone preferably has an average molar mass in the range from 10 000 g/mol to 60 000 g/mol, in particular in the range from 25 000 g/mol to 50 000 g/mol for use in compositions according to the invention. Among the copolymers, preference is given to those of vinylpyrrolidone and vinylimidazole in the molar ratio 5:1 to 1:1 with an average molar mass in the range from 5000 g/mol to 50 000 g/mol, in particular 10 000 g/mol to 20 000 g/mol.

The compositions according to the invention, which may be solid or liquid and can be present in particular as pulverulent solids, in post-compacted particulate form, as homogeneous solutions or suspensions, can in principle comprise all known ingredients that are customary in compositions of this type besides the active ingredient used according to the invention. The compositions according to the invention can comprise in particular builder substances, surface-active surfactants, bleaches based on organic and/or inorganic peroxygen compounds, bleach activators, water-miscible organic solvents, enzymes, sequestrants, electrolytes, pH regulators and further auxiliaries, such as optical brighteners, graying inhibitors, foam regulators, and also dyes and fragrances. In this connection, according to the invention, it is also possible to apply the polyamide fibers to a flat support, in particular a water-insoluble cloth, or to incorporate them, optionally with further customary ingredients of detergents or cleaners, into a bag made of water-insoluble but water-permeable material, or to produce an in particular cloth-like sheet material, for example a woven or a nonwoven, or another shaped body such as, for example, a sphere or a cube, from the polyamide present in fiber form, and to use it in this form as an additive or as a constituent of an additive in the washing or cleaning process. Alternatively to the last-mentioned embodiment, the fiber-like polyamide or a composition comprising this can be introduced into the washing or cleaning process in portions packaged into a water-soluble material, for example a polyvinyl alcohol film

The compositions according to the invention can comprise one or more surfactants, with in particular anionic surfactants, nonionic surfactants and mixtures thereof, but also cationic, zwitterionic and amphoteric surfactants being contemplated.

Suitable nonionic surfactants are in particular alkyl glycosides and ethoxylation and/or propoxylation products of alkyl glycosides or linear or branched alcohols having in each case 12 to 18 carbon atoms in the alkyl moiety and 3 to 20, preferably 4 to 10, alkyl ether groups. It is also possible to use corresponding ethoxylation and/or propoxylation products of N-alkylamines, vicinal diols, fatty acid esters and fatty acid amides which correspond to the specified long-chain alcohol derivatives as regards the alkyl moiety, and also of alkylphenols having 5 to 12 carbon atoms in the alkyl radical.

The nonionic surfactants used are preferably alkoxylated, advantageously ethoxylated, in particular primary alcohols having preferably 8 to 18 carbon atoms and on average 1 to 12 mol of ethylene oxide (EO) per mol of alcohol in which the alcohol radical can be linear or preferably methyl branched in the 2 position, or can comprise linear and methyl-branched radicals in a mixture, as are usually present in oxoalcohol radicals. In particular, however, alcohol ethoxylates with linear radicals from alcohols of native origin having 12 to 18 carbon atoms, e.g. from coconut alcohol, palm alcohol, tallow fatty alcohol or oleyl alcohol, and on average 2 to 8 EO per mole of alcohol are preferred. The preferred ethoxylated alcohols include, for example, C₁₂-C14-alcohols with 3 EO or 4 EO, C9-C₁₁-alcohols with 7 EO, C₁₃-C₁₅-alcohols with 3 EO, 5 EO, 7 EO or 8 EO, C₂-C₁₈-alcohols with 3 EO, 5 EO or 7 EO and mixtures of these, such as mixtures of C₁₂-C₁₄-alcohol with 3 EO and C12-C18-alcohol with 7 EO. The stated degrees of ethoxylation are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols with more than 12 EO. Examples thereof are (tallow) fatty alcohols with 14 EO, 16 EO, 20 EO, 25 EO, 30 EU or 40 EO. Particularly in compositions for use in machine processes, extremely low-foam compounds are usually used. These include preferably C₁₂-C₁₈-alkyl polyethylene glycol polypropylene glycol ethers having in each case up to 8 mol of ethylene oxide and propylene oxide units in the molecule. However, it is also possible to use other known low-foam nonionic surfactants, such as, for example, C₁₂-C₁₈-alkylpolyethylene glycol polybutylene glycol ethers having in each case up to 8 mol of ethylene oxide and butylene oxide units in the molecule, and also terminally capped alkyl polyalkylene glycol mixed ethers. Particular preference is also given to the alkoxylated alcohols containing hydroxyl groups, as are described in the European patent application EP 0 300 305, so-called hydroxy mixed ethers. The nonionic surfactants also include alkyl glycosides of the general formula RO(G)ₓ, in which R is a primary straight-chain or methyl-branched, in particular 2-methyl-branched aliphatic radical having 8 to 22, preferably 12 to 18, carbon atoms and G is a glycose unit having 5 or 6 carbon atoms, preferably glucose. The degree of oligomerization x, which indicates the distribution of monoglycosides and oligoglycosides, is any desired number—which, being a parameter to be determined analytically, can also assume fractional values—between 1 and 10; preferably, x is 1.2 to 1.4. Likewise of suitability are polyhydroxy fatty acid amides of the formula given below,

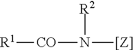

in which in R¹CO is an aliphatic acyl radical having 6 to 22 carbon atoms, R² is hydrogen, an alkyl or hydroxyalkyl radical having 1 to 4 carbon atoms and [Z] is a linear or branched polyhydroxyalkyl radical having 3 to 10 carbon atoms and 3 to 10 hydroxyl groups.

The polyhydroxy fatty acid amides are preferably derived from reducing sugars having 5 or 6 carbon atoms, in particular from glucose. The group of polyhydroxy fatty acid amides also includes compounds of the formula given below,

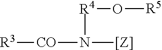

in which R³ is a linear or branched alkyl or alkenyl radical having 7 to 12 carbon atoms, R⁴ is a linear, branched or cyclic alkylene radical or an arylene radical having 2 to 8 carbon atoms and R⁵ is a linear, branched or cyclic alkyl radical or an aryl radical or an oxyalkyl radical having 1 to 8 carbon atoms, with C₁-C₄-alkyl or phenyl radicals being preferred, and [Z] is a linear polyhydroxyalkyl radical, the alkyl chain of which is substituted with at least two hydroxyl groups, or alkoxylated, preferably ethoxylated or propoxylated derivatives of this radical. [Z] is also obtained here preferably by reductive amination of a sugar such as glucose, fructose, maltose, lactose, galactose, mannose or xylose. The N-alkoxy- or N-aryloxy-substituted compounds can then be converted to the desired polyhydroxy fatty acid amides for example by reaction with fatty acid methyl esters in the presence of an alkoxide as catalyst. A further class of preferably used nonionic surfactants, which are used either as the sole nonionic surfactant or in combination with other nonionic surfactants, in particular together with alkoxylated fatty alcohols and/or alkyl glycosides, are alkoxylated, preferably ethoxylated or ethoxylated and propoxylated fatty acid alkyl esters, preferably having 1 to 4 carbon atoms in the alkyl chain, in particular fatty acid methyl esters. Nonionic surfactants of the amine oxide type, for example N-cocoalkyl-N,N-dimethylamine oxide and N-tallowalkyl-N,N-dihydroxyethylamine oxide, and of the fatty acid alkanolamide type may also be suitable. The amount of these nonionic surfactants is preferably not more than that of the ethoxylated fatty alcohols, in particular not more than half thereof. Suitable further surfactants are so-called Gemini surfactants. These are generally understood as meaning those compounds which have two hydrophilic groups per molecule. These groups are generally separated from one another by a so-called “spacer”. This spacer is generally a carbon chain which should be long enough that the hydrophilic groups have a sufficient distance to be able to act independently of one another. Surfactants of this type are generally characterized by an unusually low critical micelle concentration and the ability to reduce the surface tension of water considerably. In exceptional cases, the expression Gemini surfactants is not only understood as meaning “dimeric” surfactants of this type, but also correspondingly “trimeric” surfactants. Suitable Gemini surfactants are, for example, sulfated hydroxy mixed ethers or dimer alcohol bis- and trimer alcohol tris-sulfates and -ether sulfates. Terminally capped dimeric and trimer mixed ethers are characterized in particular by their bi- and multifunctionality. For example, the specified terminally capped surfactants have good wetting properties and are low-foam, meaning that they are suitable in particular for use in machine washing or cleaning processes. However, it is also possible to use Gemini polyhydroxy fatty acid amides or poly-polyhydroxy fatty acid amides. Also of suitability are the sulfuric acid monoesters of the straight-chain or branched C₇-C₂₁-alcohols ethoxylated with 1 to 6 mol of ethylene oxide, such as 2-methyl-branched C₉-C₁₁-alcohols with, on average, 3.5 mol of ethylene oxide (EO) or C₁₂-C₁₈-fatty alcohols with 1 to 4 EO. The preferred anionic surfactants also include the salts of alkylsulfosuccinic acid, which are also referred to as sulfosuccinates or as sulfosuccinic acid esters, and which are monoesters and/or diesters of sulfosuccinic acid with alcohols, preferably fatty alcohols and in particular ethoxylated fatty alcohols. Preferred sulfosuccinates comprise C₈- to C₁₈-fatty alcohol radicals or mixtures of these. Particularly preferred sulfosuccinates comprise a fatty alcohol radical which is derived from ethoxylated fatty alcohols which, viewed per se, are nonionic surfactants. In this connection, sulfosuccinates whose fatty alcohol radicals are derived from ethoxylated fatty alcohols with a narrowed homolog distribution are in turn particularly preferred. It is also likewise possible to use alk(en)ylsuccinic acid having preferably 8 to 18 carbon atoms in the alk(en)yl chain or salts thereof. Suitable further anionic surfactants are fatty acid derivatives of amino acids, for example of N-methyltaurine (taurides) and/or of N-methylglycine (sarcosides). Particular preference is given here to the sarcosides or the sarcosinates and here in particular sarcosinates of higher and optionally mono- or polyunsaturated fatty acids such as oleyl sarcosinate. Suitable further anionic surfactants are in particular soaps. Of suitability in particular are saturated fatty acid soaps, such as the salts of lauric acid, myristic acid, palmitic acid, stearic acid, hydrogenated erucic acid and behenic acid, and in particular soap mixtures derived from natural fatty acids, for example coconut, palm kernel or tallow fatty acids. The known alkenylsuccinic acid salts can also be used together with these soaps or as a replacement for soaps.

The anionic surfactants, including the soaps, can be present in the form of their sodium, potassium or ammonium salts and also as soluble salts or organic bases, such as mono-, di- or triethanolamine. The anionic surfactants are preferably present in the form of their sodium or potassium salts, in particular in the form of the sodium salts.

Suitable cationic surfactants are, for example, mono- and di-(C₇-C₂₅-alkyl)dimethylammonium compounds and ester quats, in particular quaternary esterified mono-, di- and trialkanolamines which have been esterified with C₈-C₂₂-carboxylic acids.

Suitable amphoteric surfactants are, for example, alkylbetaines, alkylamidobetaines, aminopropionates, aminoglycinates and amphoteric imidazolium compounds.

Surfactants are present in detergents according to the invention in quantitative fractions of preferably 5% by weight to 50% by weight, in particular from 8% by weight to 30% by weight.

A composition according to the invention preferably comprises at least one water-soluble and/or water-insoluble, organic and/or inorganic builder. Water-soluble organic builder substances include polycarboxylic acids, in particular citric acid and sugar acids, monomeric and polymeric aminopolycarboxylic acids, in particular methylglycinediacetic acid, nitrilotriacetic acid and ethylenediaminetetraacetic acid, and also polyaspartic acid, polyphosphonic acids, in particular aminotris(methylenephosphoric acid), ethylenediaminetetrakis(methylenephosphonic acid) and 1-hydroxyethane-1,1-diphosphonic acid, polymeric hydroxy compounds such as dextrin, and polymeric (poly)carboxylic acids, in particular the polycarboxylates accessible by oxidation of polysaccharides or dextrins, polymeric acrylic acids, methacrylic acids, maleic acids and mixed polymers of these, which can also comprise small fractions of polymerizable substances without carboxylic acid functionality in copolymerized form. The relative molecular mass of the homopolymers of unsaturated carboxylic acids is generally between 3000 g/mol and 200 000 g/mol, that of the copolymers is between 2000 g/mol and 200 000 g/mol, preferably 30 000 g/mol to 120 000 g/mol, in each case based on free acid. A particularly preferred acrylic acid-maleic acid copolymer has a relative molecular mass of 30 000 g/mol to 100 000 g/mol. Standard commercial products are, for example, Sokalan® CP 5, CP 10 and PA 30 from BASF. Suitable, although less preferred compounds of this class are copolymers of acrylic acid or methacrylic acid with vinyl ethers, such as vinyl methyl ethers, vinyl esters, ethylene, propylene and styrene, in which the acid fraction is at least 50% by weight. Water-soluble organic builder substances which can be used are also terpolymers which comprise, as monomers, two unsaturated acids and/or salts thereof, and also, as a third monomer, vinyl alcohol and/or an esterified vinyl alcohol or a carbohydrate, where the first acidic monomer is derived from a monoethylenically unsaturated C₃-C₈-carboxylic acid and preferably from a C₃-C₄-monocarboxylic acid, in particular from (meth)acrylic acid, and the second acidic monomer is a derivative of a C₄-C₈-dicarboxylic acid, with maleic acid being particularly preferred, and/or a derivative of an allylsulfonic acid which is substituted in the 2 position with an alkyl or aryl radical. The organic builder substances can be used in particular for producing liquid compositions, in the form of aqueous solutions, preferably in the form of 30- to 50-percent by weight aqueous solutions. All of the specified acids are generally used in the form of their water-soluble salts, in particular their alkali metal salts.

Organic builder substances of this type can be present in the compositions if desired in amounts up to 40% by weight, in particular up to 25% by weight and preferably from 1% by weight to 8% by weight. Amounts close to the specified upper limit are preferably used in pasty or liquid, in particular water-containing, compositions according to the invention.

Suitable water-soluble inorganic builder materials are in particular alkali metal silicates, alkali metal carbonates and alkali metal phosphates, which can be present in the form of their alkaline, neutral or acidic sodium or potassium salts. Examples thereof are trisodium phosphate, tetrasodium diphosphate, disodium dihydrogendiphosphate, pentasodium triphosphate, so-called sodium hexametaphosphate, oligomeric trisodium phosphate with degrees of oligomerization of 5 to 1000, in particular 5 to 50, and also the corresponding potassium salts or mixtures of sodium and potassium salts. Water-insoluble, water-dispersible inorganic builder materials which can be used are in particular crystalline or amorphous alkali metal aluminosilicates, in amounts of up to 50% by weight, preferably not more than 40% by weight and in liquid compositions in particular from 1% by weight to 5% by weight. Among these, the crystalline sodium aluminosilicates in detergent grade, in particular zeolite A, P and optionally X, alone or in mixtures, for example in the form of a co-crystallizate of the zeolites A and X (Vegobond® AX, a commercial product from Condea Augusta S.p.A.), are preferred. Amounts close to the specified upper limit are preferably used in solid, particulate compositions. Suitable aluminosilicates have in particular no particles with a particle size above 30 μm and consist preferably to at least 80% by weight of particles with a size below 10 pm. Their calcium binding capacity, which can be determined in accordance with the details in the German patent specification DE 24 12 837, is generally in the range from 100 to 200 mg of CaO per gram.

Suitable substitutes or partial substitutes for the specified aluminosilicate are crystalline alkali metal silicates, which may be present on their own in a mixture with amorphous silicates. The alkali metal silicates that can be used as builders in the compositions according to the invention preferably have a molar ratio of alkali metal oxide to SiO₂ below 0.95, in particular of 1:1.1 to 1:12, and can be present in amorphous or crystalline form. Preferred alkali metal silicates are the sodium silicates, in particular the amorphous sodium silicates, with a molar ratio Na₂O:SiO₂ of 1:2 to 1:2.8. The crystalline silicates used, which may be present on their own or in a mixture with amorphous silicates, are preferably crystalline sheet silicates of the general formula Na₂SiₓO₂ₓ₊₁.y H₂O, in which x, the so-called modulus, is a number from 1.9 to 22, in particular 1.9 to 4 and y is a number from 0 to 33 and preferred values for x are 2, 3 or 4. Preferred crystalline sheet silicates are those in which x in the specified general formula assumes the values 2 or 3. In particular, both β- and δ-sodium disilicates (Na₂Si₂O₅.y H₂O) are preferred. Also virtually anhydrous crystalline alkali metal silicates produced from amorphous alkali metal silicates and of the aforementioned general formula in which x is a number from 1.9 to 2.1 can be used in compositions according to the invention. In a further preferred embodiment of compositions according to the invention, a crystalline sodium sheet silicate with a modulus of 2 to 3 is used, as can be produced from sand and soda. Crystalline sodium silicates with a modulus in the range from 1.9 to 3.5 are used in a further preferred embodiment of compositions according to the invention. Crystalline sheet-like silicates of the formula (I) given above are sold by Clariant GmbH under the trade name Na-SKS, e.g. Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇xH₂O) or Na-SKS-4 (Na₂Si₄O₉.xH₂O, makatite). Of these, in particular Na-SKS-5 (α-Na₂Si₂O₅), Na-SKS-7 (β-Na₂Si₂O₅, natrosilite), Na-SKS-9 (NaHSi₂O₅.3H₂O), Na-SKS-10 (NaIISi₂O₅. 3H₂O, kanemite), Na-SKS-11 (t-Na₂Si₂O₅) and Na-SKS-13 (NaHSi₂O₅), but in particular Na-SKS-6 (δ-Na₂Si₂O₅) are suitable. In one preferred embodiment of compositions according to the invention, a granular compound of crystalline sheet silicate and citrate, of crystalline sheet silicate and aforementioned (co)polymeric polycarboxylic acid, or of alkali metal silicate and alkali metal carbonate is used, as is commercially available, for example, under the name Nabion® 15.

Builder substances are present in the compositions according to the invention preferably in amounts up to 75% by weight, in particular 5% by weight to 50.

Peroxygen compounds suitable for use in compositions according to the invention are in particular organic peracids or peracidic salts of organic acids, such as phthalimidopercaproic acid, perbenzoic acid or salts of diperdodecanedioic acid, hydrogen peroxide and inorganic salts which release hydrogen peroxide under the washing conditions, which include perborate, percarbonate, persilicate and/or persulfate such as caroat. If solid peroxygen compounds are to be used, these can be used in the form of powders or granules, which may also be coated in a manner known in principle. If a composition according to the invention comprises peroxygen compounds, these are present in amounts of preferably up to 50% by weight, in particular from 5% by weight to 30% by weight. The addition of small amounts of known bleach stabilizers such as, for example, of phosphonates, borates or metaborates and metasilicates, and also magnesium salts such as magnesium sulfate may be appropriate.

Bleach activators which can be used are compounds which produce, under perhydrolysis conditions, aliphatic peroxocarboxylic acids having preferably 1 to 10 carbon atoms, in particular 2 to 4 carbon atoms, and/or optionally substituted perbenzoic acid. Substances which carry O- and/or N-acyl groups of the specified number of carbon atoms and/or optionally substituted benzoyl groups are suitable. Preference is given to polyacylated alkylenediamines, in particular tetraacetylethylenediamine (TAED), acylated triazine derivates, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate, 2,5-diacetoxy-2,5-dihydrofuran and enol esters, and also aetylated sorbitol and mannitol or their described mixtures (SORMAN), acylated sugar derivatives, in particular pentaacetylglucose (PAG), pentaacetylfructose, tetraacetylxylose and octaacetyllactose, and also acetylated, optionally N-alkylated glucamine and gluconolactone, and/or N-acylated lactams, for example N-benzoylcaprolactam. The hydrophilically substituted acylacetals and the acyllactams are likewise preferably used. Combinations of conventional bleach activators can also be used. Bleach activators of this type can be present, especially in the case of the presence of aforementioned hydrogen peroxide-producing bleaches, in the customary quantitative range, preferably in amounts of 0.5% by weight to 10% by weight, in particular 1% by weight to 8% by weight, based on the total composition, but are omitted entirely when using percarboxylic acid as the sole bleach.

In addition to the conventional bleach activators, or instead of them, it is also possible for sulfonimines and/or bleach-boosting transition metal salts or transition metal complexes to be present as so-called bleach catalysts.

Suitable enzymes which can be used in the compositions are those from the class of amylases, proteases, lipases, cutinases, pullulanases, hemicellulases, cellulases, oxidases, laccases and peroxidases, and mixtures thereof. Enzymatic active ingredients obtained from fungi or bacteria, such as Bacillus subtilis, Bacillus licheniformis, Bacillus lentus, Streptomyces griseus, Humicola lanuginosa, Humicola insolens, Pseudomonas pseudoalcaligenes, Pseudomonas cepacia or Coprinus cinereus are particularly suitable. The enzymes can be adsorbed to carrier substances and/or embedded in coating substances in order to protect them against premature inactivation. They are present in the detergents or cleaners according to the invention preferably in amounts up to 5% by weight, in particular from 0.2% by weight to 4% by weight. If the composition according to the invention comprises protease, it preferably has a proteolytic activity in the range from about 100 PU/g to about 10 000 PU/g, in particular 300 PU/g to 8000 PU/g. If two or more enzymes are to be used in the composition according to the invention, this can be carried out by incorporating the two or more separate, or separately formulated (in a known manner) enzymes or by two or more enzymes formulated together in one set of granules.

The organic solvents which can be used alongside water in the compositions according to the invention, especially if they are present in liquid or pasty form, include alcohols having 1 to 4 carbon atoms, in particular methanol, ethanol, isopropanol and tert-butanol, diols having 2 to 4 carbon atoms, in particular ethylene glycol and propylene glycol, and also mixtures thereof and the ethers which can be derived from the specified compound classes. Water-miscible solvents of this type are present in the compositions according to the invention preferably in amounts not exceeding 30% by weight, in particular from 6% by weight to 20% by weight.

To establish a desired pH which does not arise by itself as a result of mixing the other components, the compositions according to the invention can comprise system- and environment-compatible acids, in particular citric acid, acetic acid, tartaric acid, malic acid, lactic acid, glycolic acid, succinic acid, glutaric acid and/or adipic acid, but also mineral acids, in particular sulfuric acid, or bases, in particular ammonium or alkali metal hydroxides. pH regulators of this type are present in the compositions according to the invention in amounts of preferably not more than 20% by weight, in particular from 1.2% by weight to 17% by weight.

Graying inhibitors have the task of keeping the dirt detached from the textile fiber suspending in the liquor. Of suitability for this are water-soluble colloids, mostly organic in nature, for example starch, size, gelatin, salts of ethercarboxylic acids or ethersulfonic acids of starch or of cellulose or salts of acidic sulfuric acid esters of cellulose or of starch. Water-soluble polyamides comprising acidic groups are also suitable for this purpose. Furthermore, it is possible to use starch derivatives other than those mentioned above, for example aldehyde starches. Preference is given to using cellulose ethers, such as carboxymethylcellose (Na salt), methylcellulose, hydroxyalkylcellulose and mixed ethers, such as methylhydroxyethylcellulose, methylhydroxypropylcellulose, methylcarboxymethylcellulose and mixtures thereof, for example in amounts of 0.1 to 5% by weight, based on the compositions.

Textile detergents according to the invention can comprise, as optical brighteners, for example derivatives of diaminostilbenedisulfonic acid or alkali metal salts thereof, although they are preferably free from optical brighteners for use as color detergents. Of suitability are, for example, salts of 4,4′ -bis(2-anilino-4-morpholino-1,3,5-triazinyl-6-amino)stilbene-2,2′-disulfonic acid or compounds with the same type of structure which carry a diethanolamino group, a methylamino group, an anilino group or a 2-methoxyethylamino group instead of the morpholino group. Furthermore, brighteners of the substituted diphenylstyryl type may be present, for example the alkali metal salts of 4,4′-bis(2-sulfostyryl)diphenyl, 4,4′-bis(4-chloro-3-sulfostyryl)diphenyl, or 4-(4-chloro-styryl)-4′-(2-sulfostyryl)diphenyl. Mixtures of the aforementioned optical brighteners can also be used.

Particularly when used in machine processes, it may be advantageous to add customary foam inhibitors to the compositions. Suitable foam inhibitors are, for example, soaps of natural or synthetic origin which have a high fraction of C₁₈-C₂₄-fatty acids. Suitable non-surfactant-like foam inhibitors are, for example, organopolysiloxanes and mixtures thereof with microfine, optionally silanized silica, and also paraffins, waxes, microcrystalline waxes and mixtures thereof with silanized silica or bis-fatty acid alkylenediamides. Mixtures of different foam inhibitors are also advantageously used, for example those of silicones, paraffins or waxes. Preferably, the foam inhibitors, in particular silicone- and/or paraffin-containing foam inhibitors, are bonded to a granular, water-soluble or dispersible carrier substance. In this connection, particular preference is given to mixtures of paraffins and bistearylethylenediamide.

The production of solid compositions according to the invention presents no difficulties and can take place in a known manner, for example by spray drying or granulation, in which case enzymes and any other thermally sensitive ingredients, such as, for example, bleach, are optionally added separately later on. To produce compositions according to the invention with an increased bulk density, in particular in the range from 650 g/l to 950 g/l, a process having an extrusion step is preferred.

To produce compositions according to the invention in tablet form, which can be single-phase or multiphase, single-colored or multicolored and in particular can consist of one layer or of two or more, in particular of two, layers, the procedure preferably involves mixing together all of the constituents—optionally in each case of one layer—in a mixer and compressing the mixture using conventional tableting presses, for example eccentric presses or rotary presses, using pressing forces in the range from about 50 to 100 kN, preferably at 60 to 70 kN. Particularly in the case of multilayered tablets, it may be advantageous if at least one layer is precompressed. This is preferably carried out at pressing forces between 5 and 20 kN, in particular at 10 to 15 kN. This gives, without problem, fracture-resistant tablets which nevertheless have sufficiently rapid solubility under application conditions and have fracture resistances and flexural strengths of normally 100 to 200 N, but preferably above 150 N. Preferably, a tablet produced in this way has a weight of 10 g to 50 g, in particular of 15 g to 40 g. The three-dimensional shape of the tablets is arbitrary and can be round, oval or cornered, with intermediate shapes also being possible. Corners and edges are advantageously rounded. Round tablets preferably have a diameter of 30 mm to 40 mm. In particular, the size of tablets with corners or a square shape, which are introduced predominantly via the dosing device for example of the dishwasher, is dependent on the geometry and the volume of this dosing device. Variants preferred by way of example have a basic area of (20 to 30 mm)×(34 to 40 mm), in particular of 26×36 mm or of 24×38 mm.

Liquid or pasty compositions according to the invention in the form of solutions comprising customary solvents, in particular water, are generally produced by simply mixing the ingredients, which can be added to an automatic mixer without dilution or in the form of a solution.

### EXAMPLES

### Example 1

### Methods for Ascertaining Analytical Characteristic Data

a) Determining the fraction of basic amino groups in the polyamides (AEG)

The precisely weighed-in sample was dissolved in a phenol/methanol mixture and potentiometrically titrated with hydrochloric acid solution (0.02 N). The consumption as far as the point of inflection of the titration curve and a corresponding blank value for the pure solvent were used to calculate the number of titratable amino groups.

b) Determination of the fraction of carboxyl end groups in the polyamides (CEG)

Depending on the amount of carboxyl end groups to be expected, samples of 0.8 to 2.0 g of polyamide were dissolved in each case in 25 ml of benzyl alcohol under reflux. After the samples had dissolved completely, in each case 0.5 ml of cresol-red was added. By means of visual titration with a solution of potassium hydroxide in ethanol (0.5 N), the amount of terminal carboxyl groups was determined, with the color change from yellow to violet serving as the end point determination. To correct the values ascertained, a blank value was determined analogously to the above procedure, except that no polyamide sample was added.

c) Determination of the specific BET surface areas of polyamide fibers

The determinations in accordance with the BET method were carried out using the instrument “Autosorb Automated Gas Sorption” (Quantachrome), with nitrogen serving as adsorbate. The activation temperature was in the range from 80 to 120° C. and the adsorption of the nitrogen was carried out at its boiling temperature (77 K).

### Example 2

### Preparation of Polyamides

Polymer A:

A polyamide 6, prepared from caprolactam, which has been controlled with an addition of hexamethylenediamine and for which the following end group balances arise:
AEG=80 mmol/kg
CEG=45 mmol/kg

Polymer B:

A polyamide 6.6, prepared from adipic acid and hexamethylenediamine, which has been regulated with an excess of hexamethylendiamine and for which the following end group balances arise:
AEG=100 mmol/kg
CEG=36 mmol/kg

Polymer C:

400.0 g of caprolactam, 85.71 g of aqueous hexamethylendiamine solution (71.4% by weight) and 16.0 g of water were weighed into a pressurized reactor. The reactor was flushed several times with nitrogen, then closed and heated to an external temperature of 270° C. (an internal temperature of ca. 260° C.). The reaction was maintained at an internal temperature of ca. 260° C. and 16 bar for 15 minutes, the pressure was then decompressed to ambient pressure over the course of one hour and then the mixture was after-condensed for 120 minutes with nitrogen flushing at an internal temperature of 260° C. Finally, the polymer was discharged from the reactor by applying a nitrogen overpressure.
AEG=1700 mmol/kg
CEG=9 mmol/kg

Polymer D:

A polyamide 6.6, prepared from adipic acid and hexamethylenediamine, in which the components were used in equimolar amunts, and for which the following end group balances arise:
AEG=43 mmol/kg
CEG=45 mmol/kg

### Example 3

### Preparation of Polyamide Particles

The polyamide particles were prepared by cryogrinding of the polymers A, B or C, dried in vacuo at 80° C. for 3 days, in a laboratory centrifugal mill The average particle size (weight average of the particle diameter) of the polyamide powders obtained in this way was about 220 μm.

Porous particles of polymer F(=polyamide 12, Vestamid® L1670 of company Evonik) were prepared by precipitation (see WO 2009/127587). For this, polyamid 12 was dissolved in phenol and pecipitated by mixing intensively with ethanol/ethylene glycol/glycerol (analog to the description of WO 2009/127587). An analysis of the end group balance revealed:
AEG=40 mmol/kg
CEG=35 mmol/kg

The average particle size of the porous particles of polymer E was determined to be 26 μm, the BET surface area was 9 m²/g.

### Example 4

### Production of Polyamide Nonwovens

a) Nonwoven FA of polymer A

To produce the nonwoven, a solution of 6.02 g of polymer A in 264 g of formic acid (98-100%, p.a.) was used (2.2% strength by weight solution). The polymer A used had a fraction of AEG of 87 mmol/kg and a fraction of CEG of 48 meq/kg.

The solution of polymer A was spun using the nanospider apparatus from Elmarco in accordance with variant 2 given above. The solution used was in a container in which a spinning electrode (drum) rotated permanently. The spinning electrode in this case was an electrode based on metal wires. Here, some of the formulation was constantly on the surface of the wires. The electric field between the drum and the counterelectrode (above the drum) caused firstly liquid jets to form from the formulation, which then lose any solvent present, or solidify, on the way to the counterelectrode. The desired nonwoven made of polyamide nanofibers formed on a polypropylene support which moved along between the two electrodes.

The following parameters were used:
Temperature: 24° C.
Relative atmospheric humidity: 28%
Voltage: 82 kV
Spinning electrode: 12-wire electrode
Distance between the electrodes: 20 cm
Electrode spin: 23 Hz
Advance of the support substrate: 19 Hz

A nonwoven consisting of polymer A was produced on the polypropylene support. Electromicroscopic analysis of the nonwoven revealed that it was composed of fibers with an average diameter of 160±30 nm

b) Nonwoven FB made of polymer B; nonwoven FD made of polymer D

To produce the nonwoven, a solution of 6.02 g of polymer B or 6.05 g of polymer D in 264 g of formic acid (98-100%, p.a.) was used (2.2% strength by weight solution).

The solution of the polymer was spun using the nanospider apparatus from Elmarco in accordance with variant 2 given above. The solution used was in a container in which a spinning electrode (drum) rotated permanently. The spinning electrode in this case was an electrode based on metal wires. Here, some of the formulation was constantly on the surface of the wires. The electric field between the drum and the counterelectrode (above the drum) caused firstly liquid jets to form from the formulation, which then lose any solvent present, or solidify, on the way to the counterelectrode. The desired nonwoven made of polyamide nanofibers formed on a polypropylene support which moved along between the two electrodes.

The following parameters were used:
Temperature: 24° C.
Relative atmospheric humidity: 30%
Voltage: 82 kV
Spinning electrode: 12-wire electrode
Distance between the electrodes: 20 cm
Electrode spin: 24 Hz Advance of the support substrate: 19 Hz

A nonwoven consisting of the polymer was produced on the polypropylene support. Electromicroscopic analysis of the nonwoven revealed that it was composed of fibers with an average diameter of 140±40 nm in both cases.

c) Nonwoven FC made of fibers consisting of a mixture of polymer B and polymer C

Firstly, in each case 20% strength by weight solutions in formic acid (98-100%, p.a.) of the polymer B and polymer C described above were prepared. To produce the nonwoven, a mixture of 225 g of polymer B solution and 25 g of polymer C solution (weight ratio of polymer B to polymer C of 9:1) was used.

The mixture was spun using the nanospider apparatus from Elmarco as described previously.

The following parameters were used:
Temperature: 24° C.
Relative atmospheric humidity: 35%
Voltage: 82 kV
Spinning electrode: 6-wire electrode
Distance between the electrodes: 25 cm
Electrode spin: 47 Hz
Advance of the support substrate: manual

The nonwoven produced in this way, which was located on the polypropylene substrate, had a BET surface area of 7 m²/g. Electromicroscopic analysis of the nonwoven revealed that it was composed of fibers with an average diameter of 140±30 nm.

d) Nonwoven FE made of polymer E

To produce the nonwoven, a solution of 6.02 g of polymer E in 264 g of formic acid (98-100%, p.a.) was used (2.2% strength by weight solution).

The solution of polymer E was spun using the nanospider apparatus from Elmarco in accordance with variant 2 given above. The solution used was in a container in which a spinning electrode (drum) rotated permanently. The spinning electrode in this case was an electrode based on metal wires. Here, some of the formulation was constantly on the surface of the wires. The electric field between the drum and the counterelectrode (above the drum) caused firstly liquid jets to form from the formulation, which then lost any solvent present, or solidified, on the way to the counterelectrode. The desired nonwoven made of polyamide nanofibers formed on a polypropylene support which moved along between the two electrodes.

The following parameters were used:
Temperature: 24° C.
Relative atmospheric humidity: 31%
Voltage: 82 kV
Spinning electrode: 12-wire electrode
Distance between the electrodes: 20 cm
Electrode spin: 23 Hz
Advance of the support substrate: 19 Hz

A nonwoven consisting of polymer E was produced on the polypropylene support. Electromicroscopic analysis of the nonwoven revealed that it was composed of fibers with an average diameter of 135±35 nm.

### Example 4

### Color Transfer Inhibition

A color transfer inhibitor-free liquid detergent W1 (5 g/l) was used to produce a wash liquor to which the colored textiles given in the table below were added and with which white textile items (6 cm×16 cm) made of cotton (Krefeld Standard) or polyamide (EMPA 406) were treated at 60° C. for 30 minutes. Moreover, otherwise identical wash liquors which, in addition to the composition W1, comprised the polyamide fiber nonwovens FA, FB, FC, FD or FE (in each case 2.5 g/l) produced as described above or, for comparison, the particulate polyamides A, B, C, D or E prepared as described above, in the same amount, were tested under the same conditions. The bleeding into the white accompanying textiles was assessed in accordance with DIN EN ISO 105-A04 on a scale from 1 (severe staining) to 5 (no staining). The results are given in the table below.

| Polymer | | | | | | | |
|---|---|---|---|---|---|---|---|
| basis | | W1¹⁾ | + FE | + E¹⁾ | | + FA | + A¹⁾ |
| AEG/ | | — | 40 | 40 | | 80 | 80 |
| mmol/kg | | | | | | | |
| CEG/ | | — | 35 | 35 | | 45 | 45 |
| mmol/kg | | | | | | | |
| BET/m²/g | | — | 8 | 9 | | 19 | 16 |
| Wash | Colored | | | | | | |
| trials | textile | | | | | | |
| Cotton | 0.5 g | 2.0 | 2.5 | 2.2 | | 2.8 | 2.0 |
| | EMPA 134 | | | | | | |
| Cotton | 0.3 g | 4.3 | 4.5 | 4.4 | | 4.8 | 4.4 |
| | EMPA 131 | | | | | | |
| Polyamide | 0.5 g | 3.0 | 3.6 | 3.2 | | 4.4 | 3.5 |
| | EMPA 134 | | | | | | |
| Polyamide | 0.3 g | 1.8 | 2.2 | 2.1 | | 2.9 | 1.9 |
| | EMPA 131 | | | | | | |
| Polyamide | 1 g | 3.4 | 3.5 | 3.5 | | 3.9 | 3.5 |
| | AISE 41-30 | | | | | | |
| Polymer | | | | | | | |
| basis | | + FD | + D¹⁾ | + FB | + B¹⁾ | + FC | + C¹⁾ |
| AEG/ | | 43 | 43 | 100 | 100 | about | 1700 |
| mmol/kg | | | | | | 260 | |
| CEG/ | | 45 | 45 | 36 | 36 | about | 9 |
| mmol/kg | | | | | | 33 | |
| BET/m²/g | | n.d. | n.d. | 15 | 13 | 7 | n.d. |
| Wash | Colored | | | | | | |
| trials | textile | | | | | | |
| Cotton | 0.5 g | 2.6 | 2.0 | 2.9 | 1.9 | 4.4 | 3.6 |
| | EMPA 134 | | | | | | |
| Cotton | 0.3 g | 4.6 | 4.3 | 4.9 | 4.3 | 4.9 | 4.5 |
| | EMPA 131 | | | | | | |
| Polyamide | 0.5 g | 3.9 | 3.2 | 4.3 | 3.3 | 4.6 | 4.0 |
| | EMPA 134 | | | | | | |
| Polyamide | 0.3 g | 3.0 | 1.8 | 3.6 | 1.8 | 4.3 | 3.1 |
| | EMPA 131 | | | | | | |
| Polyamide | 1 g | 3.9 | 3.5 | 4.1 | 3.6 | 4.6 | 3.8 |
| | AISE 41-30 | | | | | | |

¹⁾= comparative example
n.d. = not determined

It can be seen that, compared to the detergent without the addition of the polyamides and compared to the detergent with the addition of polyamides in particulate form, the white textiles upon washing with the addition of the polyamide nonwovens were less stained.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

what is claimed is:

1. A detergent, washing additive composition, laundry pretreatment composition or cleaner, comprising a color transfer inhibitor in the form of fibers consisting of water-insoluble polyamide, the average diameter of which is not more than 2 μm, and one or more surfactants, selected from the group consisting of anionic surfactants, nonionic surfactants, cationic, zwitterionic, amphoteric surfactants and mixtures thereof.

2. The composition according to claim 1, which comprises 0.05% by weight to 20% by weight of the polyamide fibers.

3. The composition of claim 1, wherein the polyamide fibers are present in the form of a sheet material.

4. The composition of claim 1, wherein the polyamide fibers have at least one of the following features i) to iv):
i) the average diameter of the polyamide fibers is in the range from 10 nm to 1000 nm;
ii) the polyamide fibers have a BET surface area in the range from 0.5 to 50 g/m²;
iii) the polyamides forming the polyamide fibers have amino groups and optionally carboxyl groups and a content of amino groups of at least 40 mmol/kg;
iv) the polyamides forming the polyamide fibers have amino groups and optionally carboxyl groups, where content of carboxyl groups have which is less than 100 meq/kg and at least 10 meq/kg is below the content of amino groups.

5. The composition of claim 1, wherein the polyamides forming the polyamide fibers are selected from polymers which are essentially composed of the following repeat units Ia and Ib, 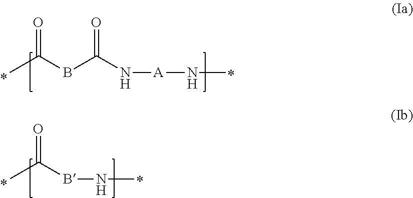
in which
A is selected from alkanediyl radicals having 2 to 20 carbon atoms, in which 1, 2, 3, 4 or 5 nonadjacent CH₂ groups can be replaced by a corresponding number of NH groups and/or in which 2 joined together CH₂ groups can be jointly replaced by a C₅-C₇-cycloalkanediyl group, and groups of the formula (A′-O)ₚ-A′, in which A′ is C₂-C₄-alkanediyl, and p is an integer in the range from 1 to 20, where the repeat units A′-O can be identical or different,
B is selected from a covalent bond, alkanediyl radicals having 1 to 20 carbon atoms, in which 2 joined together CH₂ groups can be jointly replaced by a C₅-C₇-cycloalkanediyl group, and
B′ is selected from alkanediyl radicals having 4 to 20 carbon atoms.

6. The composition of claim 1, wherein the polyamides forming the polyamide fibers are obtainable by reacting
a) at least one amino compound which has 2 primary amino groups, in particular selected from compounds of the formula V1,
H₂N-A-NH₂ (V1)
in which A is selected from alkanediyl radicals having 2 to 20 carbon atoms in which 1, 2, 3, 4 or 5 nonadjacent CH₂ groups can be replaced by a corresponding number of NH groups, and/or in which 2 joined together CH₂ groups can be jointly replaced by a C₅-C₇-cycloalkanediyl group, and groups of the formula (A″-O)ₚ-A″, in which A″ is C₂-C₄-alkanediyl and p is an integer in the range from 1 to 20, where the repeat units A″-O can be identical or different,
with
b) at least one amide-forming compound which is selected from dicarboxylic acids, their amide-forming derivatives and lactams, in particular selected from dicarboxylic acids of the formula V2
HOOC-B-COOH (V2)
and amide-forming derivatives thereof, in which B is selected from a covalent bond and alkanediyl radicals having 1 to 20 carbon atoms, in which 2 joined together CH₂ groups can be jointly replaced by a C₅-C₇-cycloalkanediyl group.

7. A method for washing colored textiles in surfactant-containing aqueous solutions, wherein colored textiles are added to a surfactant-containing aqueous solution which comprises fibers consisting of water-insoluble polyamide, the average diameter of which is not more than 2 μm.

8. A polyamide fiber of water-insoluble polyamides which have amino groups and optionally carboxyl groups, where, on average, the content of amino groups outweighs the content of carboxyl groups, wherein the average diameter of the polyamide fibers is not more than 2 μm.

9. The polyamide fiber according to claim 8, wherein the polyamides forming the polyamide fibers are selected from polymers which are essentially composed of the following repeat units Ia and Ib, 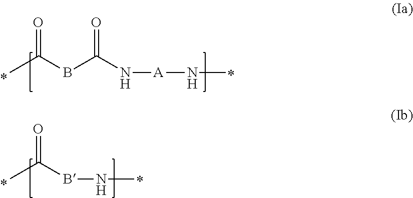
in which
A is selected from alkanediyl radicals having 2 to 20 carbon atoms, in which 1, 2, 3, 4 or 5 nonadjacent CH₂ groups can be replaced by a corresponding number of NH groups and/or in which 2 joined together CH₂ groups can be jointly replaced by a C₅-C₇-cycloalkanediyl group, and groups of the formula (A′-O)ₚ-A′, in which A′ is C₂-C₄-alkanediyl, and p is an integer in the range from 1 to 20, where the repeat units A′-O can be identical or different,
B is selected from a covalent bond, alkanediyl radicals having 1 to 20 carbon atoms, in which 2 joined together CH₂ groups can be jointly replaced by a C₅-C₇-cycloalkanediyl group, and
B′ is selected from alkanediyl radicals having 4 to 20 carbon atoms.

10. The polyamide fiber according to claim 9, where the polyamides forming the polyamide fibers are obtainable by reacting
a) at least one amino compound which has 2 primary amino groups, in particular selected from compounds of the formula V1,
H₂N-A-NH2 (V1)
in which A is selected from alkanediyl radicals having 2 to 20 carbon atoms in which 1, 2, 3, 4 or 5 nonadjacent CH₂ groups can be replaced by a corresponding number of NH groups, and/or in which 2 joined together CH₂ groups can be jointly replaced by a C₅-C₇-cycloalkanediyl group, and groups of the formula (A″-O)ₚ-A″, in which A″ is C₂-C₄-alkanediyl and p is an integer in the range from 1 to 20, where the repeat units A″-O can be identical or different,
with
b) at least one amide-foaming compound which is selected from dicarboxylic acids, their amide-forming derivatives and lactams, in particular selected from dicarboxylic acids of the formula V2
HOOC-B-COOH (V2)
and amide-forming derivatives thereof, in which B is selected from a covalent bond and alkanediyl radicals having 1 to 20 carbon atoms, in which 2 joined together CH₂ groups can be jointly replaced by a C₅-C₇-cycloalkanediyl group.

11. The polyamide fiber according to 9 which has at least one of the following features i) to iv):
i) the average diameter of the polyamide fibers is in the range from 10 nm to 1000 nm;
ii) the polyamide fibers have a BET surface area in the range from 0.5 to 50 g/m²;
iii) the polyamides forming the polyamide fibers have amino groups and optionally carboxyl groups and a content of amino groups of at least 40 mmol/kg;
iv) the polyamides forming the polyamide fibers have amino groups and optionally carboxyl groups, where content of carboxyl groups have which is less than 100 meq/kg and at least 10 meq/kg is below the content of amino groups.

12. A sheet material comprising the polyamide fibers according to claim 9, in particular in the form of a nonwoven or woven or arranged on a flat support.
